(19) United States
(12) Patent Application Publication
(10) Pub. No.: US 2007/0190309 A1
(43) Pub. Date: Aug. 16, 2007

(54) Inorganic film/substrate composite material with high transparency and method of manufacturing the same

(75) Inventors: Jun Akedo, Tsukuba-shi (JP); Masakazu Mori, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: NATIONAL INSTITUTE OF ADVANCED INDUSTRIAL SCIENCE AND TECHNOLOGY

(21) Appl. No.: 11/227,917

(22) Filed: Sep. 16, 2005

(30) Foreign Application Priority Data
Nov. 2, 2004 (JP) 2004-319933

(51) Int. Cl. B32B 5/16; B32B 15/02

(52) U.S. Cl. 428/323; 427/427; 428/332; 428/329; 428/402

(57) ABSTRACT

A novel inorganic film/substrate composite material is formed having an improved transparency. A method for producing the same is also provided. An inorganic film/substrate composite material whose inorganic film has been formed by aerosol deposition (AD method), in which fine particles of an inorganic brittle material 0.2 to 2 μm or less in size that contain few fine particles 0.15 μm or less in size are sprayed on a substrate, characterized in that the transmittance of the inorganic film is 85% or higher in the visible light region.

### CROSS-REFERENCE TO RELATED APPLICATIONS

This application claims benefit under 35 U.S.C. §119(a) of Japanese Patent Application No. 2004-319933, filed Nov. 2, 2004, the entire contents of which are incorporated herein by reference.

### BACKGROUND OF THE INVENTION

1. Field of the Invention

The present invention relates to a novel inorganic, film/substrate composite material having a high transparency and a method for producing the same, in particular, an alumina film/synthetic resin substrate composite material with a high transparency and an alumina film/glass substrate composite material with a high transparency, where the film in each is formed of alumina fine particles.

2. Description of the Related Art

A method for producing a composite structure composed of fine particles of a brittle material and a substrate has been known, wherein the fine particles are formed on the substrate by spraying on the substrate an aerosol of the fine particles of a brittle material dispersed in a gas from the tip of a nozzle at a high speed, characterized by a method of heating the substrate through the aerosol gas sprayed from the tip of a nozzle or by direct heating to soften the substrate (hereinafter referred to as aerosol deposition (AD method) (refer to Japanese Patent Laid-Open No. 2003-34003).

A composite structure of brittle materials has also been known which comprises a sintered brittle material having a polycrystalline structure made of a brittle material formed on its surface, characterized in that between the average crystal grain size (d1) of the sintered brittle material and the average crystal grain size (d2) of the polycrystalline structure, the relationship d1>d2 holds, the crystal constituting the polycrystalline structure has substantially no crystal orientation, and substantially no grain boundary layer of a glass layer exists at the crystal-crystal interfaces of the polycrystalline structure (refer to Japanese Patent Laid-Open No. 2002-309383).

Also, use of fine particles of a brittle material, which are obtained by employing, as a pre-treatment step for fine particles of a brittle material, a pre-treatment step in which mechanical impact is applied in combination with a heat treatment step, makes it possible to make aerosol deposition (AD method) at temperatures as low as ambient temperature, to form a film on a substrate at a high speed having high density, and hence to realize an ideal composite material. A patent application on this technique for high-speed coating of ceramics on a substrate to provide composite materials with beneficial properties has already been filed by the present inventors (refer to Japanese Patent Application No. 2002-309383).

In the above method, aerosol deposition (AD method) can surely be performed even at low temperatures; however, a transparent coating film is not obtained when applying the AD method to form a coating film on a plastic substrate. The coating film formed on a plastic substrate by aerosol deposition (AD method) is opaque, even though fine particles of a brittle material such as alumina (α-Al₂O₃), titania, zirconia (YSZ, ZrO₂), SiO₂, MgB₂, CeF₂, CoO, NiO, MgO, silicon nitride, aluminum nitride, silicon carbide or apatite is used.

Accordingly, the object of the present invention is to provide a coating film obtained by aerosol deposition feasible at atmospheric temperatures equal to or lower than the melting point of the plastic substrate, and preferably at ambient temperatures of 50° C. or lower, and having a high transmittance which the prior art could not realize, and a method for producing the same.

### SUMMARY OF THE INVENTION

The present invention is an inorganic film/substrate composite material composed of a substrate and an inorganic film formed on the substrate by aerosol deposition (AD method), in which aerosol of fine particles of an inorganic brittle material 0.2 to 2 μm in size that contains few fine particles 0.15 μm or less in size, characterized in that the transmittance of the inorganic film in the visible light region is 85% or more.

In the present invention, the substrate may be made of glass or a synthetic resin selected from the group consisting of polyethersulfone (PES), polycarbonate (PC), Nylon (6N), polypropylene (PP), polyimide (PI), polyethylene (PE), Teflon (registered trademark) (4F), ABS, acrylates (ACR), polyethylene terephthalate (PET) and polyoxymethylene (POM).

In the present invention, the fine particles of an inorganic brittle material may be fine particles of an inorganic material selected from the group consisting of alumina, particularly α-alumina (α-Al₂O₃), titania, zirconia (YSZ, ZrO₂), SiO₂, MgB₂, CeF₂, CoO, NiO, MgO, silicon nitride, aluminum nitride, silicon carbide and apatite.

In the present invention, fine particles of an inorganic brittle material may be used which are obtained by milling 70 to 150 g of fine particles of an inorganic brittle material with 400 to 600 g of milling balls at 100 to 400 rpm for 60 to 420 minutes.

The present invention is also a method for producing a novel inorganic film/substrate composite material in which a coating film composed of fine particles of an inorganic brittle material is formed on a substrate by spraying onto the substrate an aerosol of the fine particles of an inorganic brittle material dispersed in a gas from the tip of a nozzle at about subsonic speeds to the speed of sound in a chamber in low vacuum of 1 kPa or lower, characterized in that the temperature of the aerosol sprayed from the tip of the nozzle is controlled so that it is higher than room temperature.

The temperature of the aerosol used in the present invention may be 50° C. or lower, but greater than room temperature.

In the present invention, a nitrogen gas is preferably used as a carrier gas of the aerosol.

An inorganic film/substrate composite material composed of a substrate and an inorganic film formed on the substrate by aerosol deposition (AD method), in which aerosol of fine particles of an inorganic brittle material 0.2 to 2 μm in size that contains few fine particles 0.15 μm or less in size, characterized in that the transmittance of the inorganic film in the visible light region is 85% or more, has a dense and transparent film and can find its way into many uses as a decorative, chemical resistant or weather-resistant base material.

### BRIEF DESCRIPTION OF THE DRAWINGS

FIG. 1 is a schematic view of an aerosol deposition apparatus used in the present invention;

FIGS. 2A-2C show electron micrographs of raw material alumina fine powder without having been milled. The raw material powder is in such a state that ultra-fine particles 0.1 μm or less in size are attached on the surfaces of fine particles 0.2 to 1 μm in size. Film formation occurred at room temperature on an etched substrate, but film could not be formed;

FIG. 2D shows a substrate with an alumina film possibly formed on its surface, where the alumina film was impossible to observe with a SEM or TEM;

FIGS. 3A-3C show electron micrographs of alumina fine powder after 1-hour of milling (allowable range of 0.5 to 3 hours) (pre-treated raw material powder 2). The film formation occurred at room temperature, providing an alumina film which highly adheres to the substrate and is very dense;

FIGS. 3D-3F show a substrate with an alumina film formed on its surface;

FIGS. 3G-3H show that the alumina film highly adheres to the substrate;

FIGS. 4A-4B show electron micrographs of alumina fine powder after 7-hours of milling (allowable range of 3 hours or more) (pre-treated raw material powder 3). The film formation occurred at room temperature, providing an alumina film which adheres poorly to the substrate and is poorly dense;

FIGS. 4C-4D show the substrate with an alumina film formed on its surface having a porous film structure (α-Al₂O₃);

FIGS. 4E-4G show that there exists a clearance between the film and the substrate, indicating that the alumina film adheres poorly to the substrate and is poorly dense;

FIGS. 5A-5B show X-ray diffraction patterns of example 1;

FIGS. 6A-6B show photographs of alumina films on a PC substrate (FIG. 6A) and a PES substrate (FIG. 6B), respectively;

FIGS. 7A-7F show photographs and graphs for the comparison of the transparency among a PC substrate (FIGS. 7A-7B), a Nylon substrate (FIGS. 7C-7D) and a Polyimide substrate (FIGS. 7E-7F); and

FIG. 8 is a graph showing the results of dynamic hardness tests conducted for various types of plastic substrates.

### DETAILED DESCRIPTION OF THE PREFERRED EMBODIMENTS

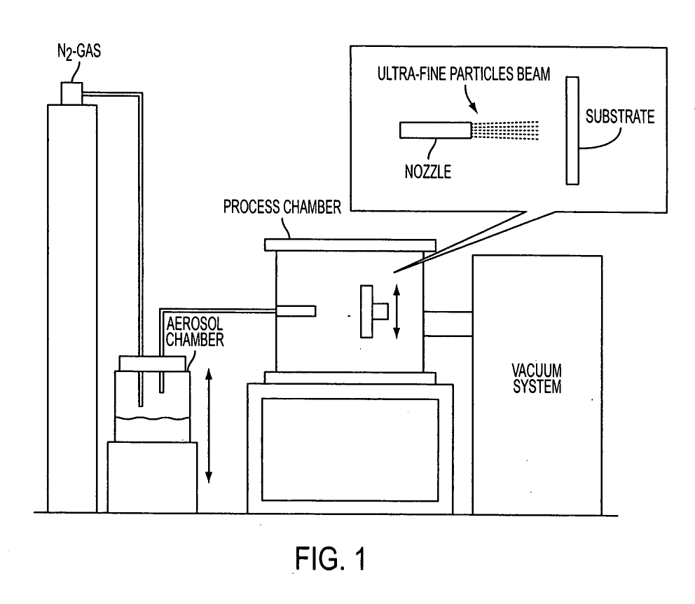

A schematic view of an aerosol deposition apparatus used in the present invention is shown in FIG. 1.

The substrate used in the present invention may be any substrate as long as it is made of glass or a synthetic resin, but preferably it is highly transparent.

Types of glass used in the present invention include: for example, silica glass, soda-lime glass, potassium glass, lead glass and borosilicate glass.

A synthetic resin used in the present invention may be any synthetic resin, but preferably it is selected from the group consisting of polyethersulfone (PES), polycarbonate (PC), Nylon (6N), polypropylene (PP), polyimide (PI), polyethylene (PE), Teflon (registered trademark) (4F), ABS, acrylates (ACR), polyethylene terephthalate (PET) and polyoxymethylene (POM).

As inorganic brittle fine particles used in the present invention, fine particles of any known inorganic material may be used, but preferably fine particles of an inorganic material selected from the group consisting of alumina, particularly α-alumina (α-Al₂O₃), titania, zirconia (YSZ, ZrO₂), SiO₂, MgB₂, CeF₂, CoO, NiO, MgO, silicon nitride, aluminum nitride, silicon carbide and apatite.

In the present invention, fine particles of an inorganic brittle material 0.2 to 2 μm in size that contain few fine particles 0.15 μm or less in size are used. The term “fine particles of an inorganic brittle material 0.2 to 2 μm that contain few fine particles 0.15 μm or less in size” means, as a measure, fine particles in which the ratio of fine particles 0.151 μm or less in size to fine particles of an inorganic brittle material 0.2 to 2 μm in size, in terms of electromicroscopic comparison of the average number between them, is 3 or less, preferably 1 or less and more preferably 0.1 to 0.5.

The fine particles of an inorganic brittle material 0.2 to 2 μm in size that contain few fine particles 0.15 μm or less in size can be obtained by conducting the following treatment.

For milling the fine particles of an inorganic brittle material, a planetary ball mill (P-6, by Fritsh) is used. Film formability was examined while conducting milling at a milling speed of 200 rpm with varying milling time. In the present invention, milling was performed for 70 to 150 g of fine particles of an inorganic brittle material with 400 to 600 g of milling balls at 100 to 400 rpm for 60 to 420 minutes (1 to 7 hours).

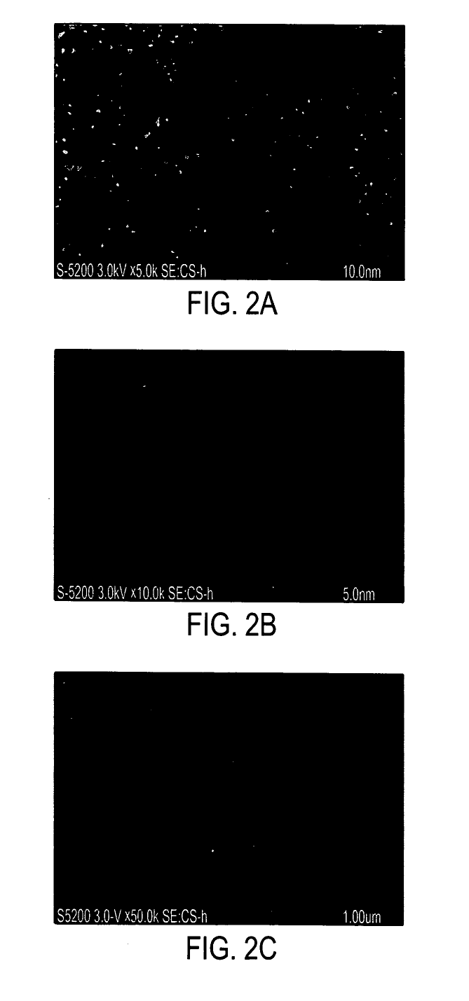

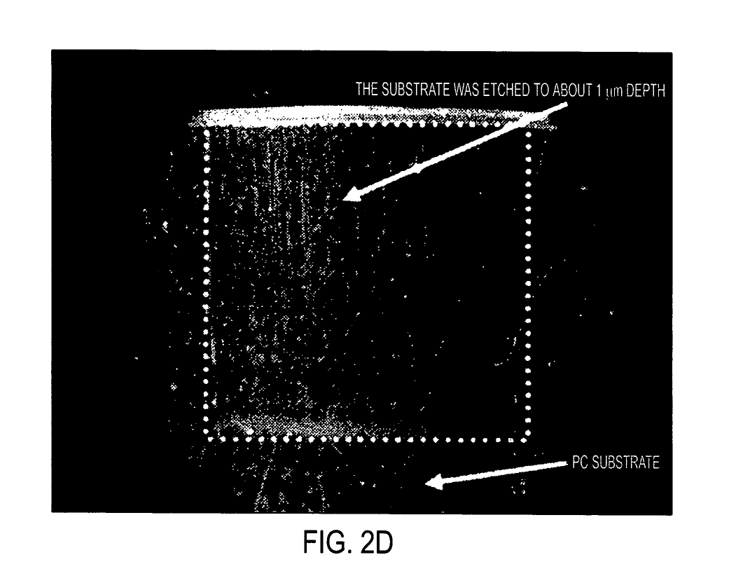

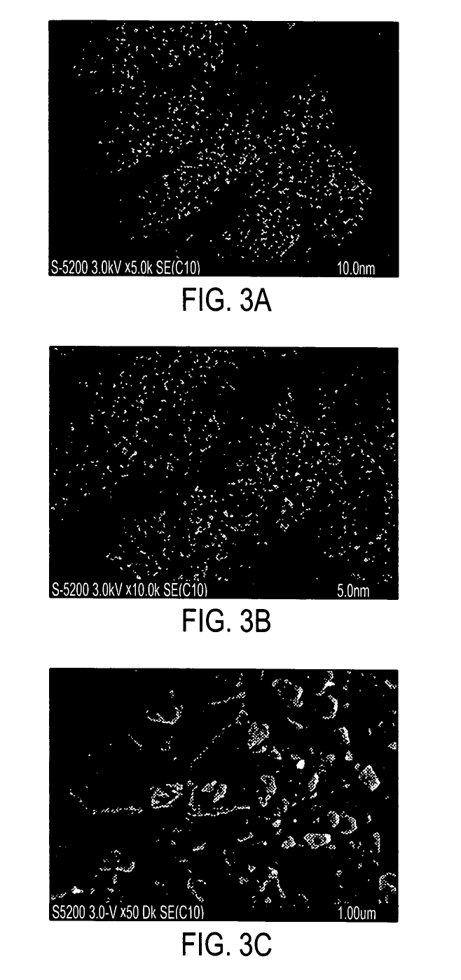

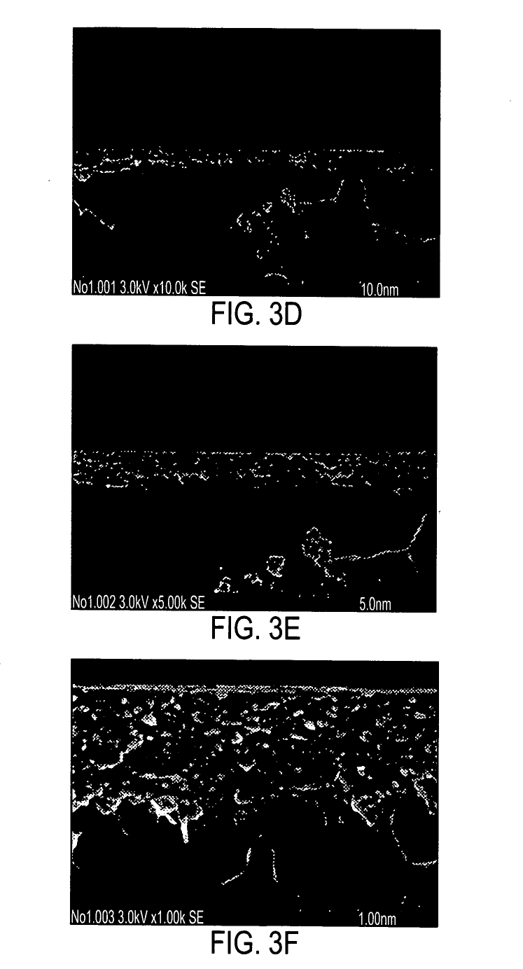

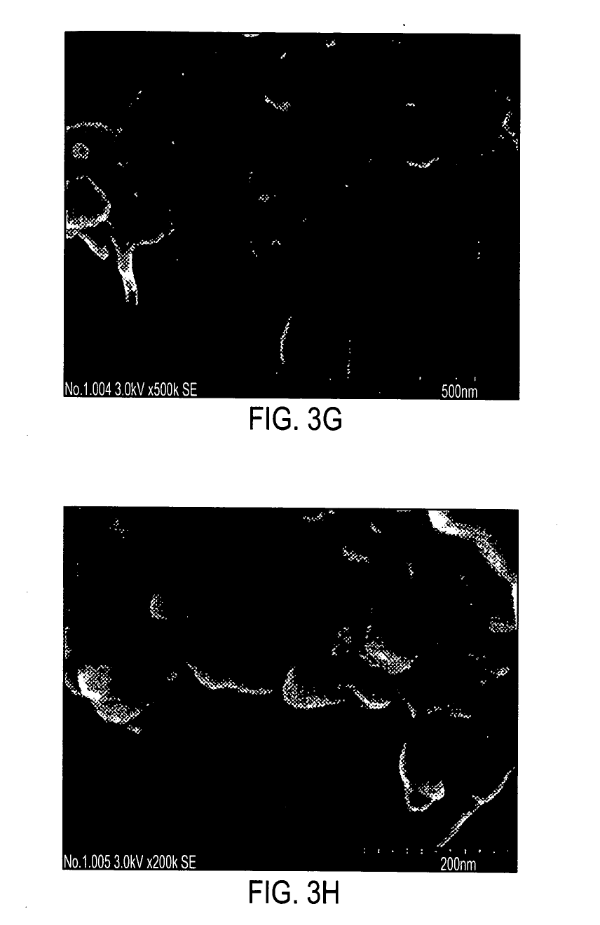

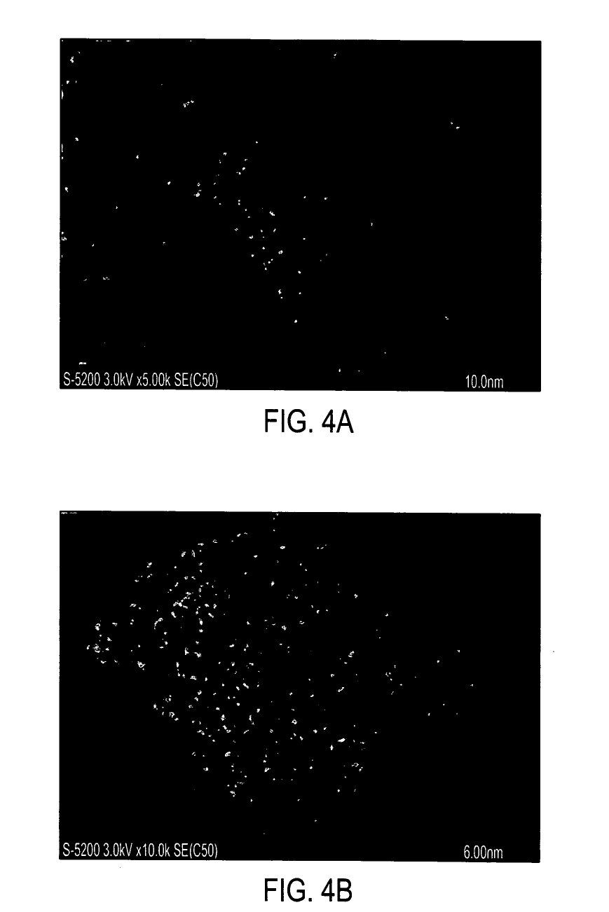

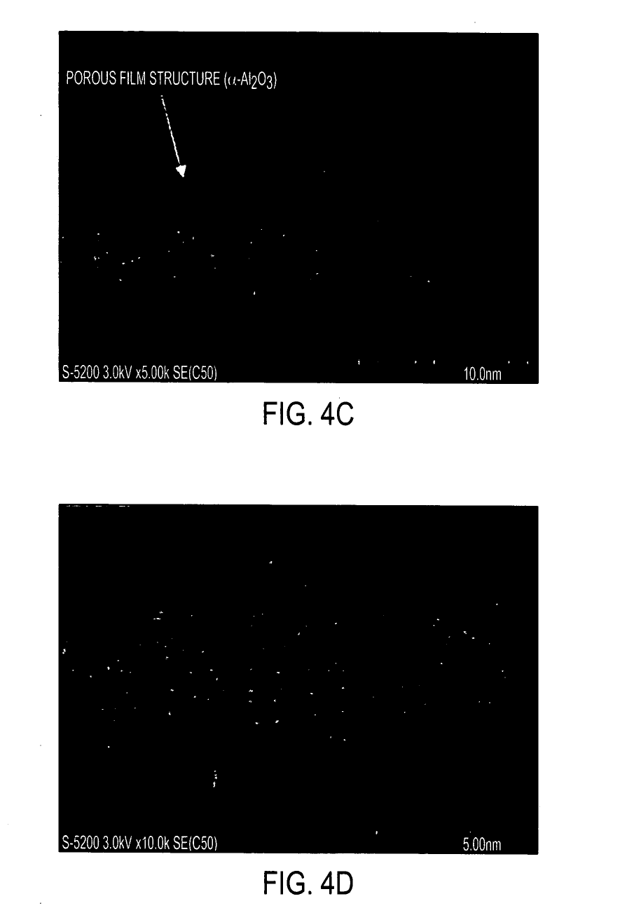

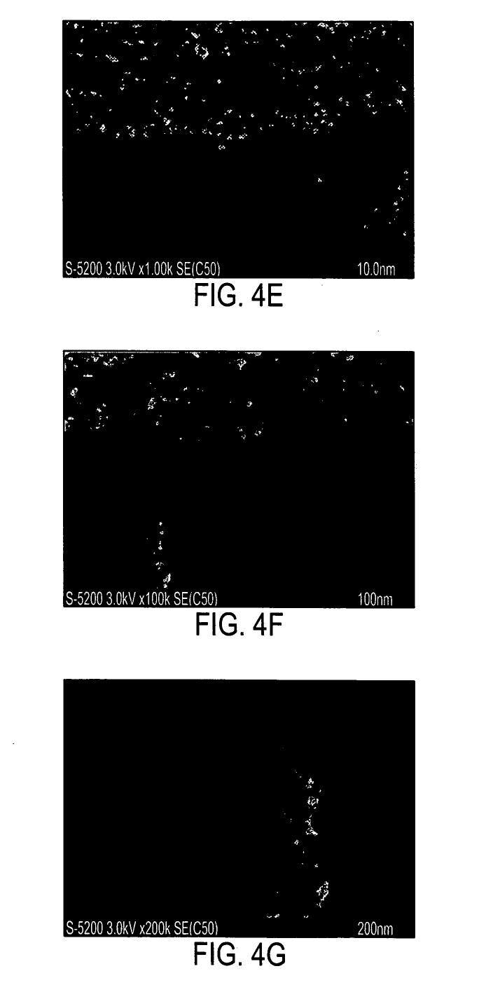

The difference in film formability of alumina fine powder due to milling time is shown in FIGS. 2 to 4.

The texture and crystal structure of the resultant alumina films were evaluated with a scanning electron microscope (VE-7800, by KEYENCE) and an X-ray diffractometer (by RIGAKU). The dynamic hardness of the plastic used in the film formation was measured with a dynamic hardness tester (DUH-201, by Shimadzu). The transmittance of the alumina films was evaluated with an ultraviolet and visible spectrophotometer (UV-2450PC, Shimadzu). The wavelength range was 300 to 800 nm.

A process for milling powder will be shown below. Milling was performed with a planetary ball mill (P-6, by Fritsh). First, a prescribed amount of zirconia ball (400 to 600 g) and fine particles of an inorganic brittle material (70 to 150 g) was put into a zirconia milling pot, and the milling pot was fixed in a milling apparatus to perform milling. Four-minute milling at 100 to 400 rpm and 1-minute stop, as a set of milling operation, was repeated until a prescribed period of time (30 to 420 minutes) had elapsed. After the milling operation was terminated, the zirconia balls and the powder were classified so that the milled powder was used for film formation. The conditions of alumina film formation on a PES substrate were evaluated while changing the state of the alumina powder by milling and heat treatment. The results are shown in Table 1. The state of film formation in the alumina powder after 30-minute milling was almost the same as that of the alumina powder after no milling (as-received alumina powder). Specifically, the film thickness was not increased even though the film forming time was increased, and a white turbid film was formed. When using alumina powder after 90-minute milling, the formation of an alumina film was made possible. When using alumina powder after more than 90-minute milling, the formation of an alumina film was also made possible. In the meantime, when alumina powder underwent heat treatment, the conditions of the film tended to be worse compared with the film formed from untreated alumina powder. The results of film formation performed on various types of plastic substrates using alumina powders after two different types of milling are shown in Table 2. For the alumina powder after milling E (milling time 180 minutes), films could be formed on substrates of 6N and PC, respectively, very thin films could be formed on substrates PE and PP, and no films could be formed on substrates of 4F and ABS. When trying film formation on a substrate of ACR, the substrate was etched. For the aluminum powder after milling C (milling time was increased to 420 minutes), film formation could be performed on substrates of 6N, PC, ABS and PP, and very thin films were formed on substrates of PE and 4F. Thus, the number of the types of plastic substrates capable of forming a film thereon was increased with the increase in milling time. An experiment confirmed that a film 1 μm or more thick could be formed even on a substrate of ACR if the film forming conditions were controlled, and use of the alumina powder after milling C (milling time 420 minutes) made it possible to form aluminum films on all types of the plastic substrates as objects to be evaluated.

TABLE 1
Alumina film condition on PES substrate

| Alumina Powder | Film Condition |
|---|---|
| as-received (not-milled) | Film thickness under 1 μm |
| Milling time @ 10 min | Film thickness under 1 μm |
| (milling condition A) | |
| Milling time @ 30 min | Film thickness under 1 μm |
| (milling condition B) | |
| Milling time @ 420 min | Film thickness over 1 μm |
| (milling condition C) | |
| Milling time @ 90 min | Film thickness over 1 μm |
| (milling condition D) | |
| Milling time @ 180 min | Film thickness over 1 μm |
| (milling condition E) | |
| Annealing at 1000° C. for 24 h | Not Fabricated |
| (Annealing condition A) | |
| Annealing at 800° C. for 24 h | Not tried |
| (Annealing condition B) | |
| Annealing at 600° C. for 24 h | Not Fabricated |
| (Annealing condition C) | |

TABLE 2
Fabrication of alumina film using various plastic substrates

| | Milling time @ | Milling time @ |
|---|---|---|
| | 180 min (milling | 420 min (milling |
| Plastic Substrate | condition E) | condition C) |
| Nylon (6N) | Film thickness | Film thickness |
| | over 1 μm | over 1 μm |
| Polycarbonate (PC) | Film thickness | Film thickness |
| | over 1 μm | over 1 μm |
| Polyethylene (PE) | Film thickness | Film thickness |
| | under 1 μm | under 1 μm |
| Polypropylene (PP) | Film thickness | Film thickness |
| | under 1 μm | over 1 μm |
| Teflon (4F) | Not Fabricated | Film thickness |
| | | under 1 μm |
| Acrylonitrile-butadiene- | Not Fabricated | Film thickness |
| styrene (ABS) | | over 1 μm |
| Acrylic (ACR) | Etched acrylic | Not tried |
| | substrate | |

Performing film formation of the present invention using a helium gas as a carrier gas resulted in the formation of a white turbid film with poor uniformity. Use of a nitrogen gas as a carrier gas made it possible to improve the conditions of the film formation, such as transparency and uniformity. Increasing the flow rate of the carrier gas tended to worsen the film conditions. The best result was obtained when the flow rate of the carrier gas was about 3 to 6 L/min. However, the optimum conditions of carrier gas flow rate vary depending on the conditions under which milling of powder was performed.

The distance between the nozzle and the substrate is preferably about 15 mm. If the distance is decreased to about 5 mm, the resultant film tends to be white turbid. In the experiment where alumina powder after 420-minute milling was used, if a simple trap was attached midway between the tube connecting the aerosol chamber and the process chamber, the transparency of the resultant film was improved.

The present invention will be described in detail referring to Examples below without limiting the present invention thereto. Although the invention has been described with respect to specific embodiments, the details are not to be construed as limitations, for it will become apparent that various embodiments, changes and modifications maybe resorted to without departing from the spirit and scope thereof, and it is understood that such equivalent embodiments are intended to be included within the scope of this invention.

### EXAMPLE 1

Fine particles of alpha-alumina after planetary milling E (milling time of 180 minutes) were used. The fine particles were located in an aerosol generator, a nitrogen gas cylinder was opened so as to introduce the nitrogen gas at a flow rate of 3 L/min into the aerosol generator through a conveying pipe, and aerosol of fine particles of aluminum oxide dispersed in the nitrogen gas was generated.

The aerosol was further conveyed towards the structure forming chamber through the conveying tube and was sprayed onto the substrate while accelerating the flow of the aerosol to a high speed. In this example, as substrates, substrates of polycarbonate (PC), silica glass, polyethersulfone (PES) and polyethylene terephthalate (PET) were used.

The speed of the fine particles of aluminum oxide was accelerated from a subsonic speed to the speed of sound. The aluminum oxide fine particles having been accelerated enough and having energy of motion collided with the substrate and were crushed into finer particles by the energy generated at the time of collision, and the fine fragment particles joined with each other on the surface of the substrate and then formed a dense alumina structure. The substrate was rocked by XY stage 17, so that an alumina structure having a prescribed area was formed on its surface. Under such control, an aluminum oxide film (structure) 1 to 2 μm thick was formed.

The operations so far were performed in the ambient temperature process, without heating. During the film formation, an exhaust pump was being operated to keep the film forming chamber under vacuum of 1 kPa or lower. During the film formation, a fine amplitude vibration was also being operated to vibrate the conveying tube, whereby the fine particles were prevented from depositing on the inner wall of the conveying tube. This made it possible to avoid the harmful effect that the depositing fine particles left the inner wall and were sprayed from the nozzle in the form of an agglomerated particle.

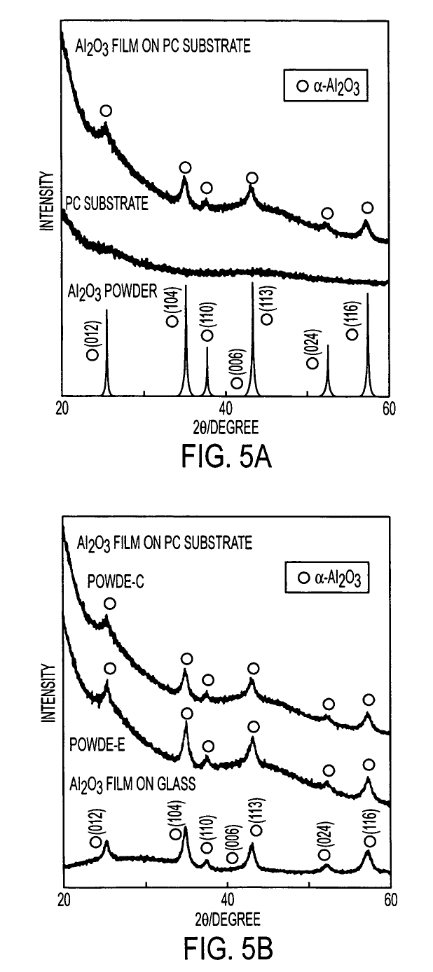

The XRD measurements of the alumina film formed on a PC substrate are shown in FIG. 5. In the following the method of XRD measurement will be described. Used for the measurement were an automatic X-ray diffractometer (RINT 2000/PC, by Rigaku), RINT 2 000 vertical goniometer and a thin film standard multipurpose sample carrier as an attachment. The measurement was performed after setting a sample, which is composed of a plastic substrate and a film 10×10 mm (length×width) and 10 μm or less in thickness formed on the substrate, in a measuring holder as an attachment, attaching the measuring holder to the diffractometer at the required position, and starting up a measuring soft (standard measurement) as an attachment, with X-ray tube: Cu; scan mode: 2θ/θ and continuous mode; and measuring conditions: initial angle 20°, terminating angle 60°, sampling width 0.02°, scan speed 0.2°/min, voltage 40 V, current 40 A, diverging slit 1°, vertical diverging limiting slit 5 mm, scattering slit 1.16 mm and receiving slit 0.15 mm.

FIG. 5A shows the XRD measurements of the alumina powder, the PC substrate and the alumina film on the PC substrate. The figure shows that the PC substrate alone had an amorphous structure. The figure also shows that the measurements after the film formation had diffraction peaks, which indicates that a crystalline film was formed on the substrate. Comparing the diffraction pattern of the formed film with that of the alumina powder used in the film formation, no changes are observed in the intensity ratio and diffraction pattern. Thus, it is apparent that a film having a crystalline structure of alfa-alumina was formed on the PC substrate. However, the peaks are smaller in intensity and broader.

FIG. 5B shows the XRD measurements of the alumina film formed on a glass substrate using alumina powder without milling and the alumina films formed on the PC substrate using alumina powders after milling under different milling conditions. The figure shows that there was no difference in diffraction pattern between the film formed on the glass substrate and the films formed on the PC substrate. From the facts that the peak intensity was decreased and the diffraction peaks were broadened both in the glass substrate and in the plastic substrate, probably the film structure does not vary depending on the types of the substrates, and thus, the film forming mechanisms on the glass substrate and the PC substrate are probably analogous. Comparing the diffraction patterns of the films formed using the alumina powder after milling E (milling time of 180 minutes) and the alumina powder after milling C (milling time of 420 minutes), there is observed no change in the crystal structure after the film formation depending on the milling conditions.

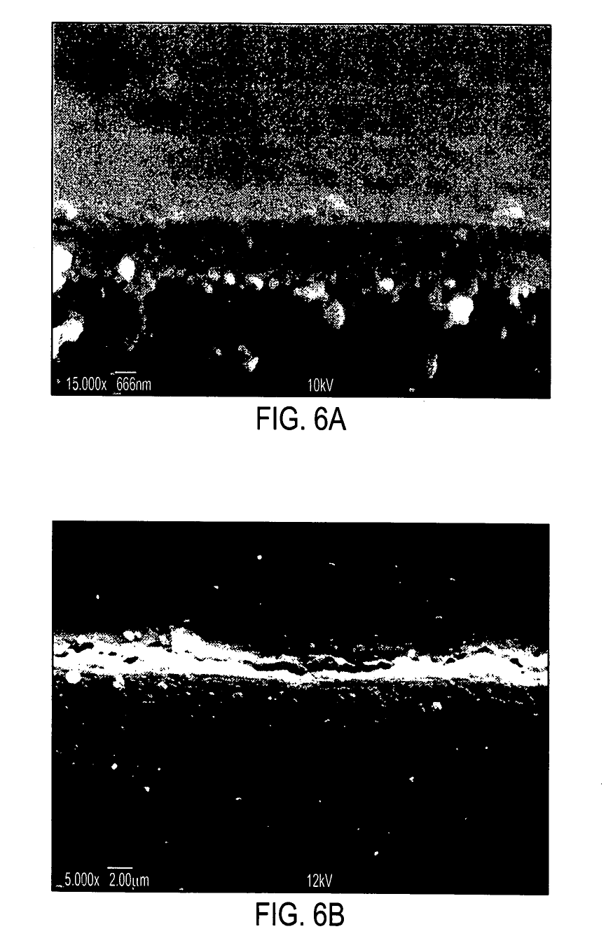

The observations of the cross sections of the alumina films formed on the PC substrate and on a PES substrate are shown in FIGS. 6A-6B. The figures indicate that a very dense alumina film about 1 to 2 μm thick was formed on each substrate. Since neither peeling nor intermediate layer is observed in the interface of each of the plastic substrates and each of the formed films, films having good adhesion to plastic substrates were formed.

### EXAMPLE 2

An alumina film (structure) 1 to 2 μm thick was formed on each substrate in the same manner as example 1 using alumina fine particles after milling E (milling time 180 minutes). PC, 6N and PI substrates were used.

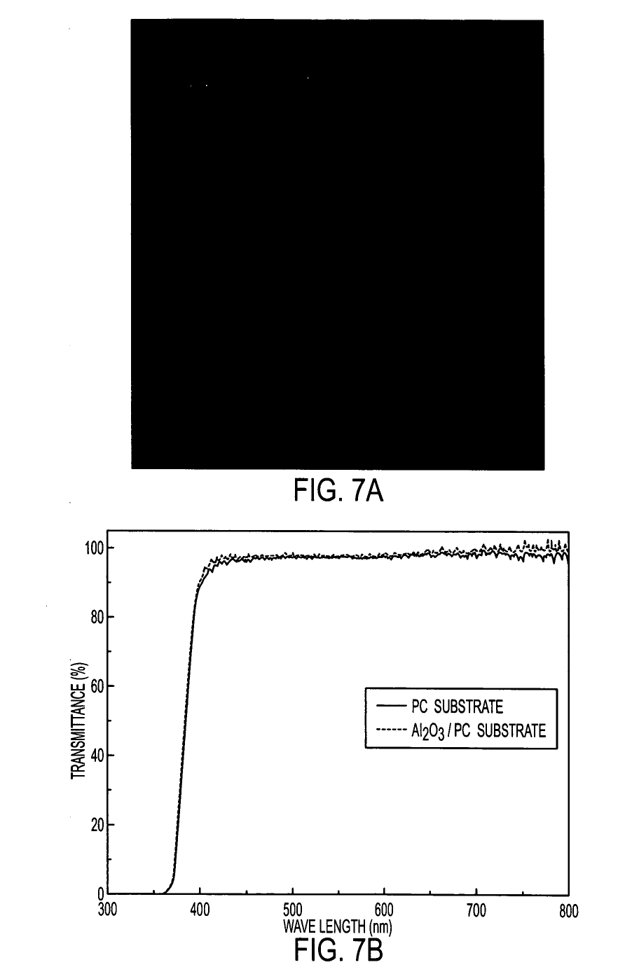

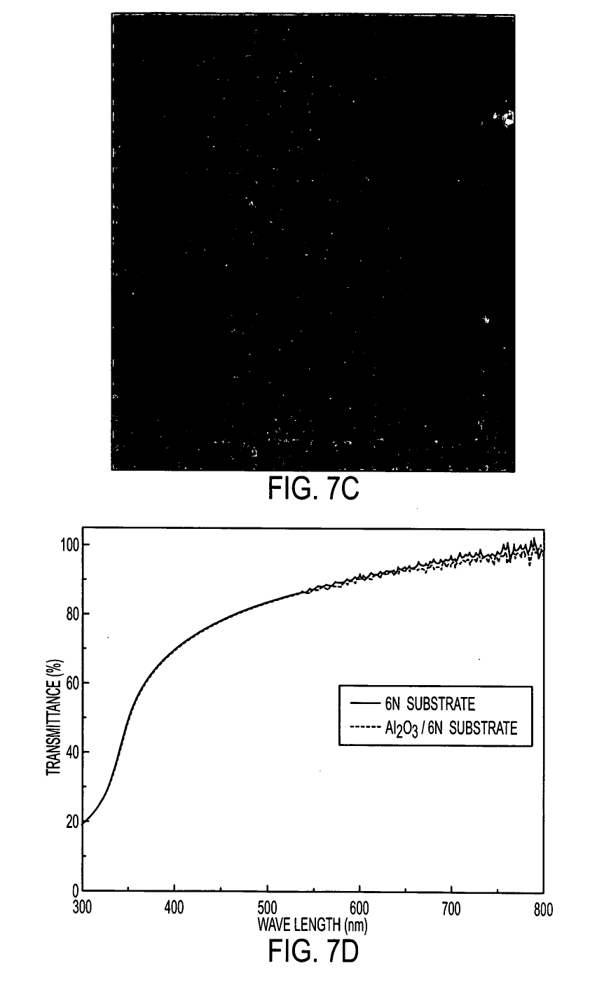

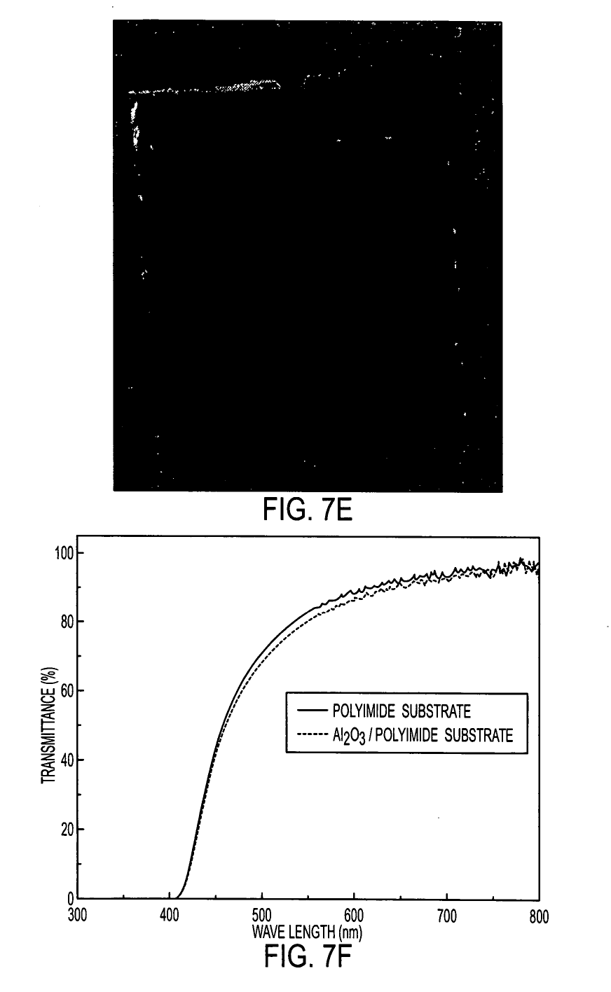

The transmittance was measured in the following manner. The measurement was performed for samples each composed of a plastic substrate and an inorganic film 40 mm×20 mm (length×width) and 1 to 3 μm in thickness formed on the substrate with an ultraviolet and visible spectrophotometer (UV-2450PC, by Shimadzu) equipped with an integrating sphere attachment for UV 2200 series (ISR-2200, Shimadzu). A film holder into which a sample had been inserted was attached to the entrance window portion of the integrating sphere. Then, the measurement was performed by first starting up UVPC as an attached software, performing the calibration of the instrument, setting the measuring conditions on the software as follow: transmittance measuring mode; measuring range of 800 to 300 nm, high scan speed; slit width of 1.0 nm; Auto sample pitch, and performing the auto zero operation. The transmittance measurements of each of the alumina films formed on PC, 6N and PI substrates are shown in FIG. 7. The measurements were plotted with wave length as abscissa and transmittance as ordinate. In the figure, the two lines in each graph show the transmittance of each plastic substrate and that of the sample composed of the plastic substrate and an alumina film formed thereon, respectively. The appearances of the samples used in the measurement are also shown in the figure. The measurements indicate that the transmittance of the samples with films formed on the PC and 6N substrates, respectively, was almost the same as that of the substrates. In the sample with a film formed on the PI substrate, the transmittance was slightly decreased, for example, it was decreased by only several percents at 600 nm. Thus, it is apparent that the alumina films 0.5 μm or more thick can have a transmittance of 85% or higher at wavelengths ranging from 400 to 800 nm, and preferably the alumina films 1 μm or more thick can have a transmittance of 90% or higher at wavelengths ranging from 400 to 800 nm.

The evaluation of the transmittance in the wavelengths ranging from 300 to 800 nm confirms that the alumina films formed on the substrates of PC, 6N and PI have a very high transmittance in the above measured region. Probably, it is possible to realize formation of films at high speeds/formation of crystalline and dense films at ambient temperature, which characterize the AD method, in the formation of films of oxide ceramics including alumina on various types of resin substrates by further optimizing the film forming conditions.

So far, it has been shown that films with a high transmittance can be formed on various types of plastic substrates. However, the measurements show that depending on the film forming conditions, a phenomenon may occur that a plastic substrate is etched by the film formation or the thickness of the formed film is below 1 μm. The measurements also show that alumina films formed under the same conditions may be different in thickness depending on the types of the plastic substrate used. These results may be attributed to the effects of the substrate characteristics on the way alumina forms a film.

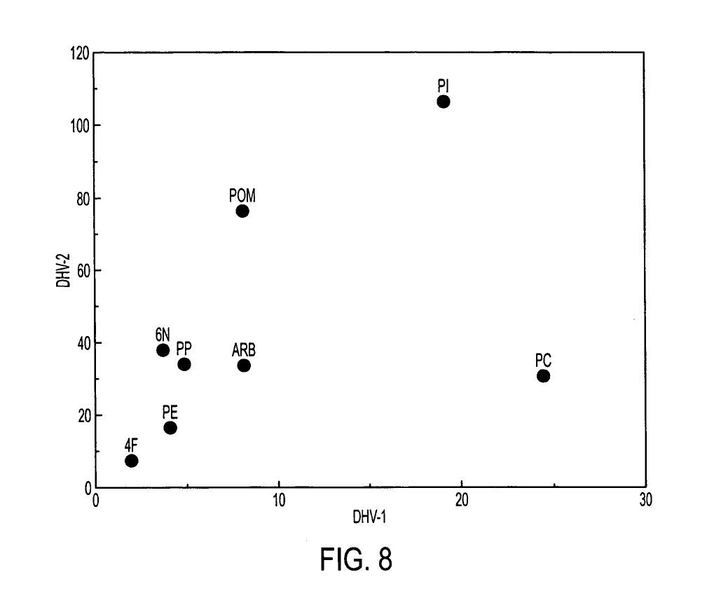

Then, the dynamic hardness of the plastic substrates used in the film formation was measured. The measurement of hardness was performed in the following manner. For the measurement, a dynamic hardness tester (DUH-201, by Shimadzu) and a Vickers diamond pyramid indenter were used. The measurement was performed by first setting the sample to be measured in a sample holder, starting up the measuring software as an attachment, and setting the measuring conditions as follows: scan mode: load-unload mode; test force: 10 g; holding time: 15 s; and loading speed: 1 (1.35 [gf/sec]). As the measurements, the values of the arithmetical mean of the 7-point measurements were used. The dynamic hardness of the plastic substrates used for the film formation was evaluated. The measurements of the dynamic hardness of the plastic substrates of PC, 6N, PP, PE, 4F, ARB, ACR, PI and POM are shown in FIG. 8. The measurements were plotted with DHV-1 (dynamic hardness obtained without taking into consideration the plastic deformation) as abscissa and DHV-2 (dynamic hardness obtained taking into consideration the plastic deformation) as ordinate. In the measured plastic substrates, the value DHV-1 ranges from 4 to 25, while the value DHV-2 ranging from 7 to 105. This indicates that an alumina film can be formed on any one of the measured plastic substrates, as long as the film forming conditions were controlled. There was observed no effect on the film formation by the values of DHV-1 and DHV-2.

The composite material of the present invention is a unique composite material that did not exist until now. The inorganic film/substrate composite material has a highly dense and transparent film, thereby finding its way into many uses such as a decorative, chemical resistant or weather-resistant base material. Thus, its industrial applicability is high.

What is claimed is:

1. An inorganic film/substrate composite material, wherein the inorganic film is formed by aerosol deposition (AD method), in which an aerosol of fine particles of an inorganic brittle material 0.2 to 2 μm in size that contains few fine particles 0.15 μm or less in size is sprayed on a substrate, and has a transmittance of 85% or higher in the visible light region.

2. The inorganic film/substrate composite material according to claim 1, wherein the substrate is made of glass or a synthetic resin selected from the group consisting of polyethersulfone (PES), polycarbonate (PC), Nylon (6N), polypropylene (PP), polyimide (PI), polyethylene (PE), Teflon (4F), ABS, acrylates (ACR), polyethylene terephthalate (PET) and polyoxymethylene (POM).

3. The inorganic film/substrate composite material according to claim 1, wherein the fine particles of the inorganic brittle material are fine particles of an inorganic material selected from the group consisting of alumina, titania, zirconia (YSZ, ZrO₂), SiO₂, MgB₂, CeF₂, CoO, NiO, MgO, silicon nitride, aluminum nitride, silicon carbide and apatite.

4. The inorganic film/substrate composite material according to any one of claims 1 to 3, wherein the fine particles of the inorganic brittle material are obtained by milling 70 to 150 g of fine particles of the inorganic brittle material with 400 to 600 g of milling balls at 100 to 400 rpm for 60 to 420 minutes.

5. A method for producing an inorganic film/substrate composite material, wherein a film composed of fine particles of an inorganic brittle material is formed on a substrate by spraying onto the substrate an aerosol of the fine particles of the inorganic brittle material dispersed in a gas from the tip of a nozzle at about a subsonic speed to the speed of sound in a chamber under low vacuum of 1 kPa or less, and wherein the temperature of the aerosol sprayed from the tip of the nozzle is controlled so that it is higher than room temperature.

6. The method for producing an inorganic film/substrate, composite material according to claim 5, wherein the temperature of the aerosol sprayed from the tip of the nozzle is 50° C. or less but higher than room temperature.

7. The method for producing an inorganic film/substrate composite material according to claim 5 or 6, wherein a nitrogen gas is used as a carrier gas of the aerosol.

8. The inorganic film/substrate composite material according to claim 1, wherein the substrate is made of glass selected from the group consisting of silica gas, soda-lime glass, potassium glass, lead glass and borosilicate glass.

9. The inorganic film/substrate composite material according to claim 1, wherein the fine particles of the inorganic brittle material are fine particles of alumina.

10. The inorganic film/substrate composite material according to claim 1, wherein the fine particles of the inorganic brittle material 0.2 to 2 μm in size that contains few fine particles 0.15 μm or less in size have a ratio of fine particles 0.15 μm or less in size to fine particles of an inorganic brittle material 0.2 to 2 μm in size, in terms of electromicroscopic comparison of the average number between them, is 1 or less.

11. The inorganic film/substrate composite material according to claim 10, wherein the ratio of fine particles 0.15 μm or less in size to fine particles of an inorganic brittle material 0.2 to 2 μm in size is 0.1 to 0.5.

12. The inorganic film/substrate composite material according to claim 9, wherein the alumina film is 0.5 μm or more.

13. The method for producing an inorganic film/substrate composite material according to claim 5, wherein the fine particles of the inorganic brittle material are obtained by milling 70 to 150 g of fine particles of the inorganic brittle material with 400 to 600 g of milling balls at 100 to 400 rpm for 60 to 420 minutes.

14. The method for producing an inorganic film/substrate composite material according to claim 5, wherein a nitrogen gas is used as a carrier gas of the aerosol and the flow rate of the nitrogen gas is about 3 to 6 L/min.

15. The method for producing an inorganic film/substrate composite material according to claim 5, wherein a distance between the nozzle and the substrate is about 15 mm.

16. The method for producing an inorganic film/substrate composite material according to claim 5, wherein a trap is attached midway between a tube connecting the aerosol chamber and the process chamber.
